(19) United States
(12) Patent Application Publication
(10) Pub. No.: US 2012/0096705 A1
(43) Pub. Date: Apr. 26, 2012

(54) Process tray for head stack assembly, shipping tool and manufacturing method for the same

(75) Inventors: Shujin Jiang, DongGuan (CN); Qinping Zhao, DongGuan (CN)

(73) Assignee: SAE Magnetics (H.K.) Ltd., Hong Kong (CN)

(21) Appl. No.: 12/929,216

(22) Filed: Jan. 7, 2011

(30) Foreign Application Priority Data
Oct. 26, 2010 (CN) 201010539391.6

(51) Int. Cl. G11B 5/127; B65D 21/02; B25B 11/00

(52) U.S. Cl. 29/603.09; 269/289 R; 206/503

(57) ABSTRACT

A process tray for head stack assembly includes a main tray and at least one jig. Each jig has a main body with one set of locating holes formed thereon and two elastic arms respectively extending from two sides of the main body for providing force to hold the head stack assembly. The main tray has a main frame and a supporting frame disposed within and connected to the main frame for supporting the jig and/or the head stack assembly. The supporting frame has at least one set of locating bumps formed thereon for locating at least one jig on the main tray by respectively inserting the locating bumps into the locating holes formed on the jig. The process tray of the present invention can carry the head stack assembly during the whole head stack assembly manufacturing process, thereby simplifying the HSA manufacturing process, increasing productive efficiency and reducing the cost.

### FIELD OF THE INVENTION

The present inventions relates to devices for manufacturing disk drive devices, and more particularly to a process tray for head stack assembly (HSA) of the disk drive device, a shipping tool and manufacturing method for the HSAs with the same.

### BACKGROUND OF THE INVENTION

One known type of information storage device is a disk drive device that uses magnetic media to store data and a movable read/write head that is positioned over the magnetic media to selectively read from or write to the magnetic media.

FIG. 1 provides an illustration of a typical disk drive 100. Referring to FIG. 1, a typical disk drive 100 includes a head stack assembly (HSA) 110 with one or several head gimbal assemblies (HGAs) 111 having slider(s) thereon, a magnetic disk 120 mounted on a spindle motor 130 which causes the magnetic disk 120 to spin, and a motor base 140 to enclose the above-mentioned components. The slider(s) flies over the surface of the magnetic disk 120 at a high velocity to read data from or write data to concentric data tracks on the magnetic disk 120, which is positioned radially by an arm coil assembly (ACA) 112 having (e.g. by epoxy potting or overmolding) a fantail spacer 113. Generally, a voice coil motor (VCM) 114 embedded in the fantail spacer 113 is used to drive the ACA 112. The HSA 110 further includes a flexible printed circuit assembly (FPCA) 115 with a flexible printed cable (FPC) 116. The flexible printed circuit assembly (FPCA) 115 and the ACA 112 are connected together by the flexible printed cable (FPC) 116 to form an arm flexible circuit assembly (AFA).

A traditional HSA is a very precision and critical part in the disk drive, so frequent cleaning and inspection/testing of the HSA, such as slider and FPC of the HSA are required during the whole HSA manufacturing process. As shown in FIG. 2, a HSA manufacturing process using traditional trays includes the following steps: assembling an AFA on a metal plate tray in flow line (step S111 shown in FIG. 2); loading the AFA onto a cleaning jig (step S112 shown in FIG. 2); cleaning the AFA for the first time (step S113 shown in FIG. 2); shifting the AFA from the cleaning jig to a AFA flow line tray (step S114 shown in FIG. 2) (the AFA flow line tray should be cleaned before step S114); inspecting or testing the AFA carried on the AFA flow line tray (step S115 shown in FIG. 2); loading the AFA onto the cleaning jig (step S116 shown in FIG. 2); cleaning the AFA for the second time (step S117 shown in FIG. 2); shifting the AFA from the cleaning jig to the AFA flow line tray again (step S118 shown in FIG. 2) (the AFA flow line tray should be cleaned before step S118); shipping the flow line tray with the AFA to a next station (step S119 shown in FIG. 2); assembling the AFA with a bearing and a HGA to form a HSA (step S120 shown in FIG. 2); loading the HSA onto a HSA injection tray (step S121 shown in FIG. 2); cleaning the HSA (step S122 shown in FIG. 2); shifting the HSA from the HSA injection tray to a HSA shipping tray for being shipped to a next station (step S123 shown in FIG. 2) (the HSA shipping tray should be cleaned before step S123).

As indicated above, the HSA manufacturing process at least needs four different kinds of trays, such as metal plate tray, AFA flow line tray, HSA injection tray and HSA shipping tray. Thereby, during the whole manufacturing process, the HSA is loaded/unloaded so many times that much no-value stations and operators are needed in the process. All these increase the manufacturing cost. Moreover, when implementing the operations of loading/unloading the AFA/HSA, the hands of operator contact with the AFA/HSA directly, thereby carrying more contamination to the AFA/HSA.

Hence, it is desired to provide a process tray for HSAs to overcome the above-mentioned drawbacks.

### SUMMARY OF THE INVENTION

One objective of the present invention is to provide a process tray for carrying the HSA during the whole HSA manufacturing process, thereby simplifying the manufacturing process, increasing the productive efficiency and reducing the cost thereof.

Another objective of the present invention is to provide a shipping tool with a plurality of the process trays for conveying the HSAs, thereby increasing the productive efficiency and reducing the cost thereof.

Still another objective of the present invention is to provide a manufacturing method for a head stack assembly by using the process tray, thereby simplifying the manufacturing process, increasing the productive efficiency and reducing the cost thereof.

To achieve above objectives, the present invention provides a process tray for head stack assembly including a main tray and at least one jig. Each jig has a main body with one set of locating holes formed thereon and two elastic arms respectively extending from two sides of the main body for providing force to hold the head stack assembly. The main tray has a main frame and a supporting frame disposed within and connected to the main frame for supporting the jig and/or the head stack assembly. The supporting frame has at least one set of locating bumps formed thereon for locating at least one jig on the main tray by respectively inserting the locating bumps into the locating holes formed on the jig.

Preferably, the supporting frame has several sets of locating bumps which are uniformly-spaced for locating several jigs.

Preferably, the jig further includes a handle formed on the top of the main body for facilitating picking up the jig.

Preferably, the handle has a slot formed thereon for facilitating dropping water.

Preferably, the elastic arm includes a protrusion portion and a first clamping portion extending from the bottom end of the protrusion portion, and the jig further includes a second clamping portion extending from the bottom of the main body and disposed between the first clamping portions.

Preferably, both of the first clamping portions have at least one clawlike bump, and the second clamping portion has at least one clawlike bump and a locating pole.

Preferably, the supporting frame has at least one set of locating pillars formed thereon for locating at least one head stack assembly on the main tray by respectively inserting the locating pillars into positioning holes formed on the head stack assembly.

Preferably, the supporting frame includes two inner bars connecting to the main frame and several sets of supporting bars which are uniformly-spaced formed thereon for supporting several head stack assemblies.

Preferably, each set of supporting bars includes a first supporting bar and a second supporting bar, and each set of locating pillars includes a first locating pillar formed on the first supporting bar and a second locating pillar formed on the second supporting bar.

Preferably, the first supporting bar has a plurality of first stoppers formed around the first locating pillar and the second supporting bar has a plurality of second stoppers formed around the second locating pillar.

Preferably, the main frame has a top bar, a bottom bar parallel to the top bar and two opposite side bars connecting to the top bar and bottom bar to form four corners, each corner having an upside with two protrusions and a cutout and a downside with a protrusion.

Preferably, the size of protrusions and cutout in one corner is different from that in the other corners.

Preferably, the top bar, the bottom bars and the supporting frame all have draft angle for facilitating dropping water.

The present invention further provides a shipping tool for carrying the head stack assemblies. The shipping tool includes a plurality of process trays which are stacked with each other. Each of the process trays includes a main tray and at least one jig. Each jig has a main body with one set of locating holes formed thereon and two elastic arms respectively extending from two sides of the main body for providing force to hold the head stack assembly. The main tray has a main frame and a supporting frame disposed within and connected to the main frame for supporting the jig and/or the head stack assembly. The supporting frame has at least one set of locating bumps formed thereon for locating at least one jig on the main tray by respectively inserting the locating bumps into the locating holes formed on the jig.

Preferably, the shipping tool of the present invention further includes a top process tray stacked on the process trays. The top process tray has a downside facing to the process trays and an upside opposite to the downside. The upside of the top process tray is flat.

Preferably, the shipping tool further includes a bottom process tray stacked by the process trays. The bottom process tray has an upside facing to the process trays and a downside opposite to the upside. The downside of the bottom process tray is flat.

The present invention further provides a manufacturing method for a head stack assembly using the process tray, the method including the steps of: loading an arm flexible circuit assembly to the jig and loading the jig with the arm flexible circuit assembly to the main tray; cleaning the process tray with the arm flexible circuit assembly for a first time; removing the jig with the arm flexible circuit assembly from the main tray and inspecting or testing the arm flexible circuit assembly carried on the jig; loading the jig with the arm flexible circuit assembly to the main tray again; cleaning the process tray with the arm flexible circuit assembly for a second time; shipping the process tray with the arm flexible circuit assembly to a next station; assembling a head gimbal assembly and a bearing to the arm flexible circuit assembly to form a head stack assembly; cleaning the head stack assembly carried on the process tray; removing the jig from the main tray and leaving the head stack assembly on the main tray for being conveyed to another station.

In comparison with the prior art, the process tray of the present invention can replace all kinds of trays or cleaning jig traditionally used in the AFA/HSA process, as indicated above, during the whole process for manufacturing HSA, the AFA/HSA are always carried by the same process tray, thus the load/unload operations of the HSA can be reduced, in turn, no-value stations and operators could be reduced. Thereby the productive efficiency is improved and then the manufacturing cost is reduced. Furthermore, because of the process tray of the present invention including a jig to clamp the AFA/HSA, it is able to avoid contacting the AFA/HSA directly by hand during the whole manufacturing process. Therefore, cross contamination of the AFA/HSA is avoided and visual yield can be improved.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a perspective view of a conventional disk drive;

FIG. 2 is a flowchart of a traditional manufacturing process for a HSA;

FIG. 3a shows a top view of a process tray of the present invention carrying the traditional HSA shown in FIG. 1;

FIG. 3b shows a bottom view of the process tray and the traditional HSA shown in FIG. 3a;

FIG. 4a is a perspective view of a jig of the process tray shown in FIG. 3a;

FIG. 4b is another perspective view of the jig shown in FIG. 4a;

FIG. 4c is a top view of the jig shown in FIG. 4a;

FIG. 4d is a bottom view of the jig shown in FIG. 4a;

FIG. 5a is a schematic diagram illustrating the jig shown in FIG. 3a carrying a AFA of the HSA shown in FIG. 3a;

FIG. 5b is another schematic diagram illustrating the jig shown in FIG. 3a carrying a AFA of the HSA shown in FIG. 3a;

FIG. 6a is a perspective view of a main tray of the process tray shown in FIG. 3a;

FIG. 6b is a top view of the main tray shown in FIG. 6a;

FIG. 6c is a left side view of the main tray shown in FIG. 6a;

FIG. 6d is right side view of the main tray shown in FIG. 6a;

FIG. 6e is a partial enlarged view of the main tray shown in FIG. 6a;

FIG. 7 is a schematic diagram showing a shipping tool in use according to an embodiment of the present invention;

FIG. 8 is a flowchart showing a manufacturing method for a HSA using the process tray according to an embodiment of the present invention.

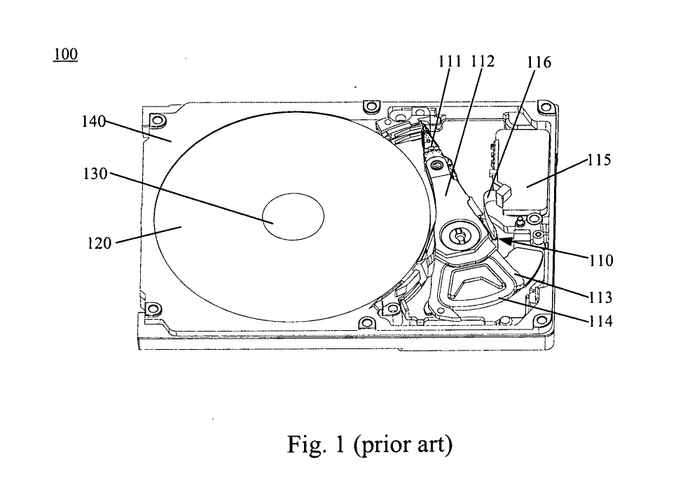

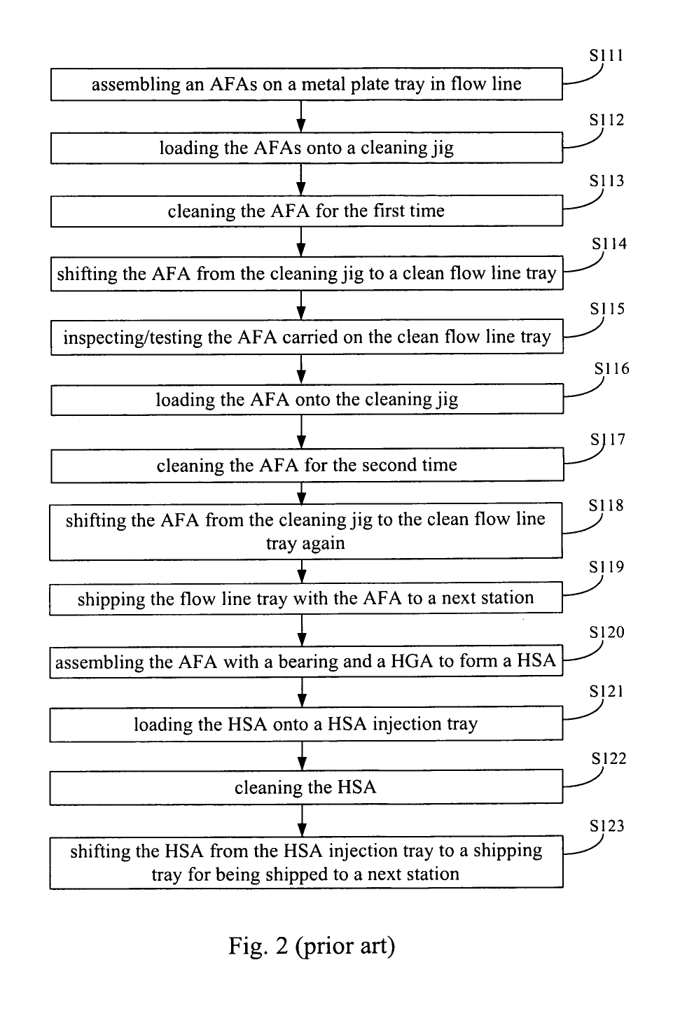

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a process tray for head stack assembly including a main tray and at least one jig. Each jig has a main body with one set of locating holes formed thereon and two elastic arms respectively extending from two sides of the main body for providing force to hold the head stack assembly. The main tray has a main frame and a supporting frame disposed within and connected to the main frame for supporting the jig and/or the head stack assembly. The supporting frame has at least one set of locating bumps formed thereon for locating at least one jig on the main tray by respectively inserting the locating bumps into the locating holes formed on the jig. The process tray of the present invention can replace all kinds of trays or cleaning jig traditionally used in the AFA/HSA process and it almost can avoid contacting the AFA/HSA directly by hand during the whole manufacturing process. Thus, with the use of the process tray, the productive efficiency of the AFA/HSA can be improved, the manufacturing cost can be reduced, and the cross contamination thereof can be avoided.

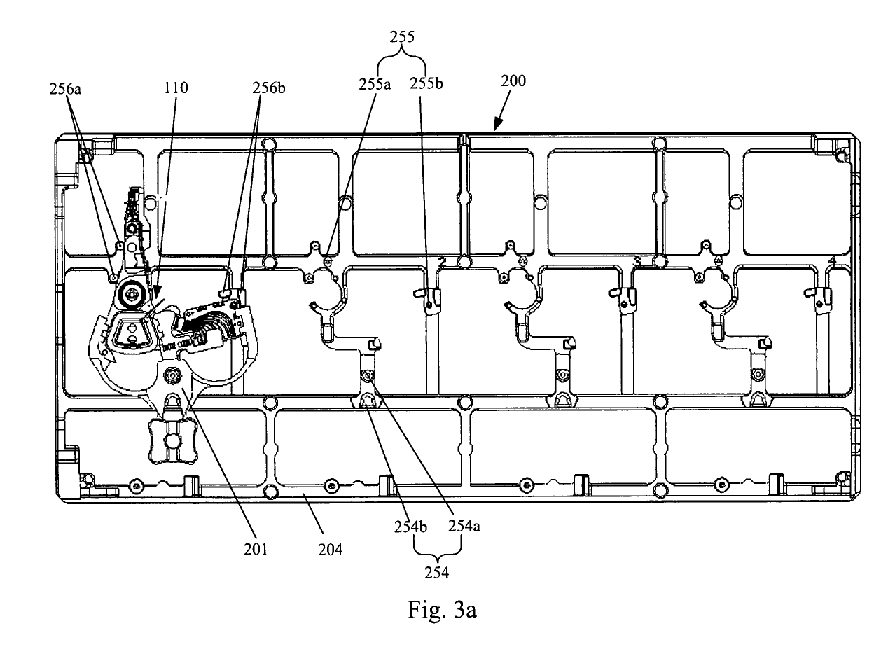

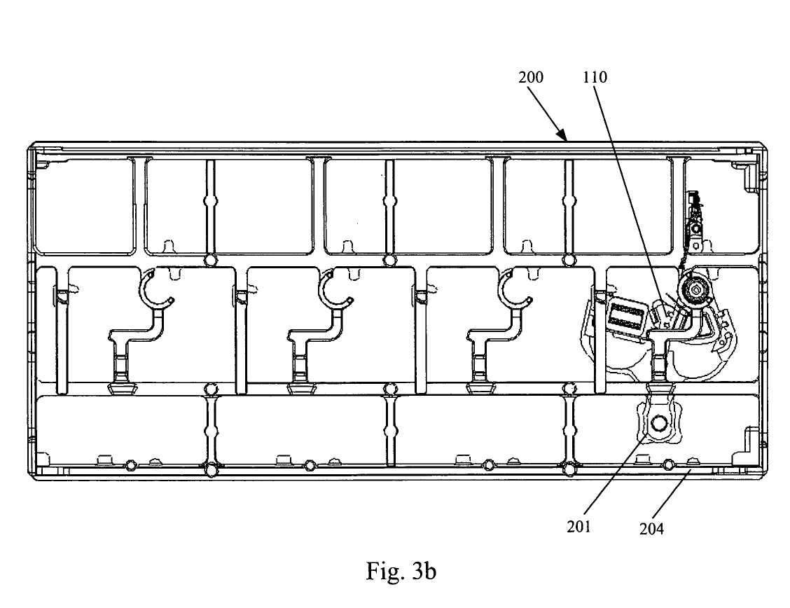

FIG. 3a shows a top view of a process tray 200 of the present invention carrying the traditional HSA 110. FIG. 3b shows a bottom view of a process tray 200 of the present invention carrying the traditional HSA 110. As illustrated in FIGS. 3a and 3b, the process tray 200 includes a jig 201 for clamping the HSA 110 and a main tray 204 for supporting the jig 201 and HSA 110. Preferably, the process tray 200 is made of polycarbonate or polyether imide. The structure of the jig 201 and the main tray 204 will be described detailedly as follows.

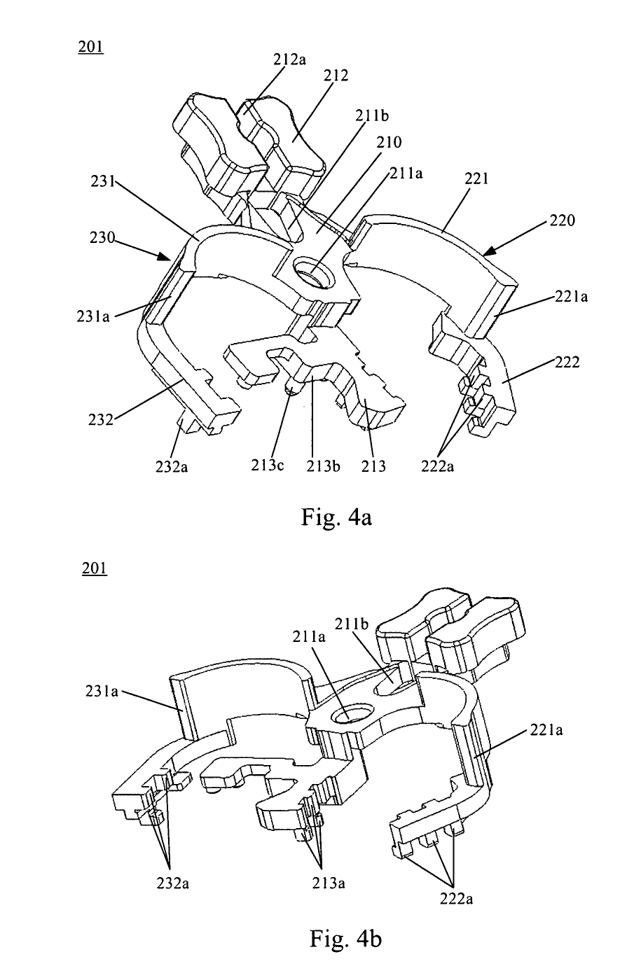

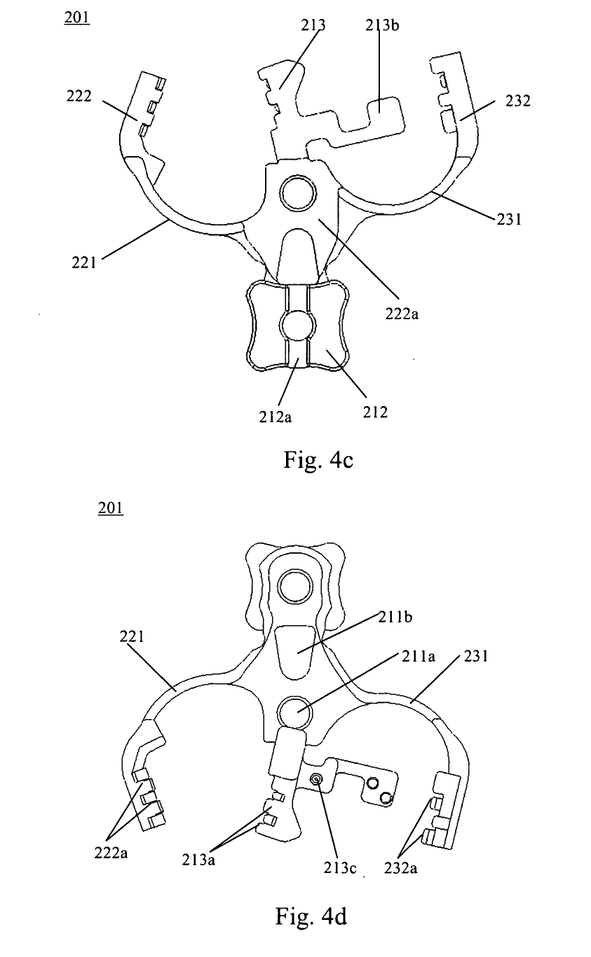

Referring to FIGS. 4a-4d, the jig 201 includes a main body 210 and two elastic arms 220, 230 extending from two sides of the main body 210, respectively. The elastic arms 220 and 230 have bent structure for providing force to hold the HSA 110. Concretely, the elastic arm 220 includes a cambered protrusion portion 221 and a first clamping portion 222 which extends from the bottom end of the protrusion portion 221. The first clamping portion 222 has several clawlike bumps 222a formed thereon. Similarly, the elastic arm 230 includes a cambered protrusion portion 231 and a first clamping portion 232 which extends from the bottom end of the protrusion portion 231. The first clamping portion 232 has several clawlike bumps 232a formed thereon. Furthermore, the end 221a of the protrusion portion 221 protrudes above the first clamping portion 222 and the end 231a of the protrusion portion 231 protrudes above the first clamping portion 232, based on such step structures, the elastic arms 220 and 230 are easy to be expanded by applying force to the two ends 221a and 231a, thereby the HSA 110 can be unloaded from the jig 201 easily.

In this embodiment, the main body 210 of the jig 201 has two locating holes 211a and 211b form thereon. Both of the locating holes 211a and 211b are through holes. The locating hole 211a is a round hole while the locating hole 211b is irregular. The jig 201 further includes a handle 212 formed on the top of the main body 210 and a second clamping portion 213 extending from the bottom of the main body 210. The handle 212 is provided for facilitating picking up the jig 201 and it further has a slot 212a formed thereon for facilitating dropping water when cleaning the jig. The second clamping portion 213 is disposed between the first clamping portions 222 and 232 for assisting the first clamping portions 222 and 232 to clamp the HSA 110. Similar to the first clamping portions 222 and 232, the second clamping portion 213 also has several clawlike bumps 213a formed thereon, furthermore it has a supporting portion 213b with a locating pole 213c formed thereon.

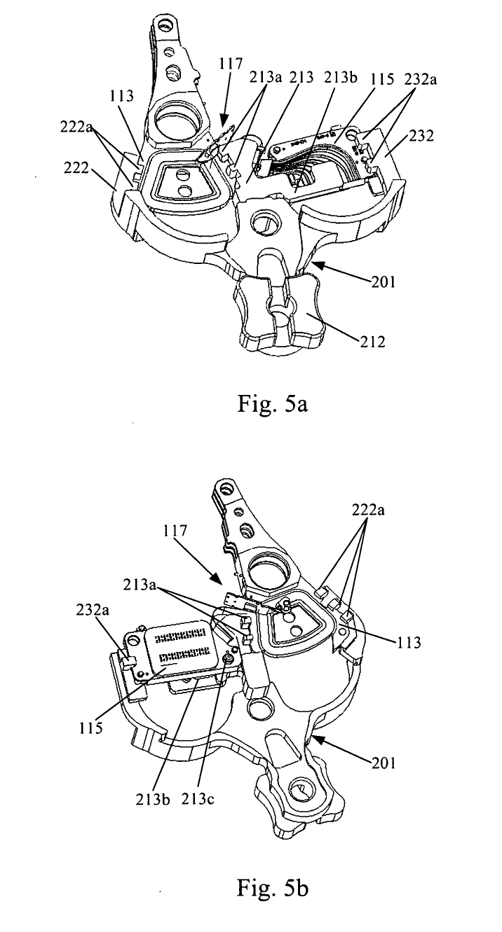

FIGS. 5a-5b show the jig 201 clamping the AFA 117 of the HSA 110. Referring to FIG. 5aand FIG. 5b, when loading the AFA 117 onto the jig 201, the fantail spacer 113 of the AFA 117 is kept between the first clamping portion 222 and the second clamping portion 213 by force supplied by the first clamping portion 222, and is clamped by the clawlike bumps 222a and 213a to avoid escaping from the jig 201. While, the FPCA 115 of the AFA 117 is disposed between the first clamping portion 232 and the second clamping portion 213, and is clamped by the clawlike bumps 232a of the first clamping portion 232, meanwhile, the locating pole 213c of the second clamping portion 213 is inserted into a mounting hole formed on the FPCA 115, thereby the FPCA 115 is located on and supported by the supporting potion 213b of the second clamping portion 213.

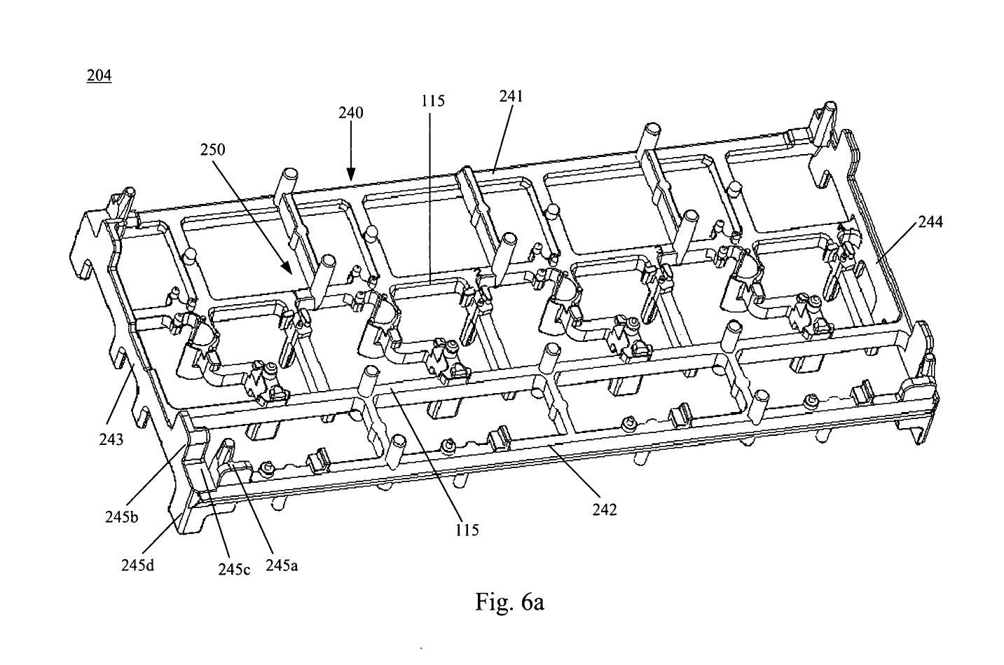

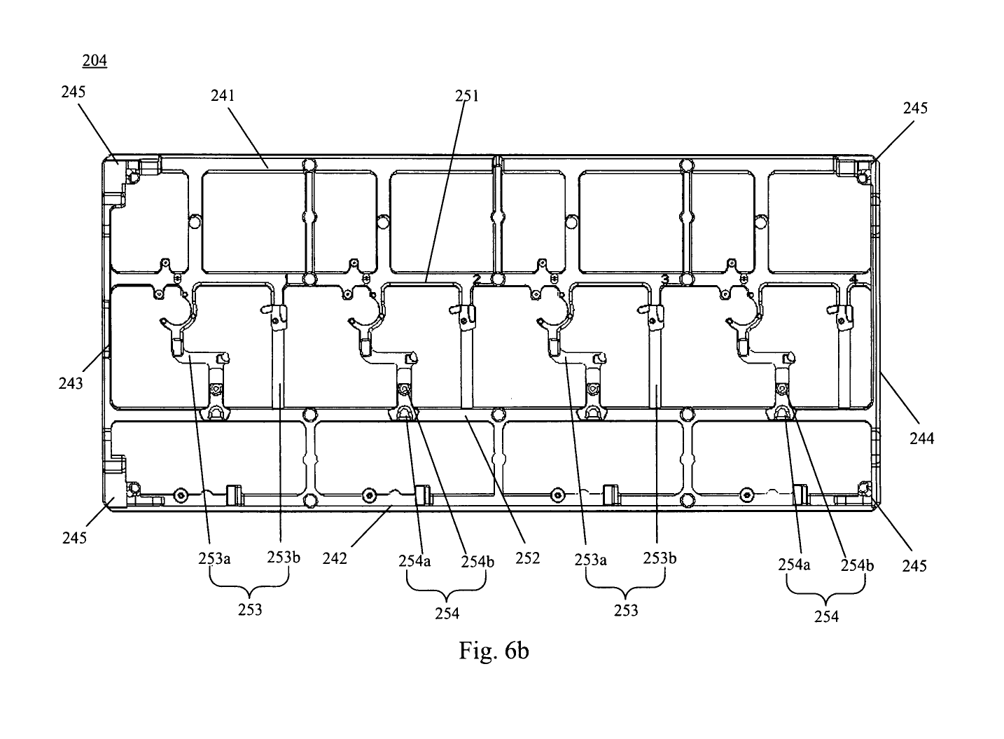

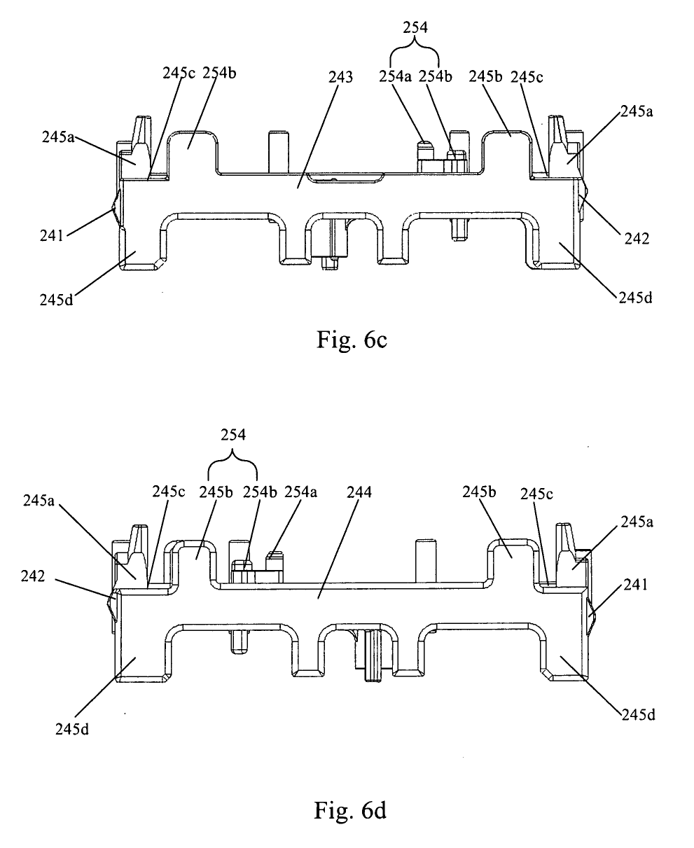

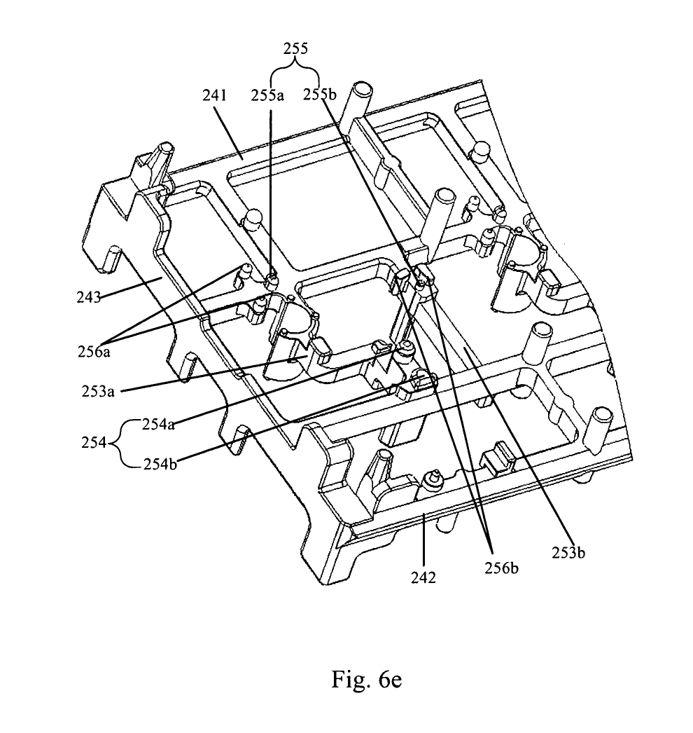

Now, referring to FIGS. 6a-6e, the main tray 204 includes a main frame 240 and a supporting frame 250 disposed within the main frame 240 and connected to the main frame 240. The main frame 240 includes a top bar 241, a bottom bar 242 and two opposite side bars 243 and 244. The bottom bar 242 is parallel to the top bar 241, two side bars 243 and 244 are parallel to each other, and all of them are connected to each other thereby the main frame 240 is formed to be a rectangular frame which has four corners 245. Concretely, each corner 245 has an upside and a downside, the upside of the corner 245 has two protrusions 245a, 245b and a cutout 245c between the two protrusions 245a and 245b, while the downside of the corner 245 only has one protrusion 245d. Based on this structure, a plurality of the main trays 204 are able to be stacked by aligning and engaging the protrusion 245d of one of the process tray with the cutout 245c of another process tray. In a preferable embodiment, the size of protrusions and cutout in the right and bottom corner is different from those protrusions and cutout in the other corners, thereby preventing the process trays 200 from being stacked in wrong direction. Preferably, the top bar 241, bottom bar 242 and the supporting frame 250 have big draft angle for facilitating dropping water when cleaning. In this embodiment, the inside surfaces of the bottom bar 242 and the top bar 241 are slants and their outside are both triangle shape, as shown in FIG. 6c and FIG. 6d.

As illustrated in FIG. 6b, in this embodiment, the supporting frame 250 includes two parallel inner bars 251, 252 and four sets of supporting bars 253. The four sets of supporting bars 253 are uniformly-spaced formed on the supporting frame 250 for supporting four jigs and/or HSAs. Each inner bar 251/252 is connected to the two side bars 243,244 and parallel to the top bar 241 and bottom bar 242. Each set of supporting bars 253 includes a first supporting bar 253a and a second supporting bar 253b. The first supporting bar 253a and the second supporting bar 253b are disposed between the two inner bars 251,252 and connected to them. Furthermore, the supporting frame 250 has four sets of locating bumps 254 formed on the four set of supporting bars 253, respectively, thereby the locating bumps 254 are also uniformly-spaced formed on the supporting frame 250 and they are provided for locating four jigs 201 on the main tray 202.

Referring to FIG. 6e, concretely, each set of locating bumps 254 includes two locating bumps 254a and 254b which are formed on one end of the first supporting bar 253a. The shape of the locating bump 254a is corresponding to the locating holes 211a of the jig 201 for being inserted into the locating holes 211a. The shape of the locating bump 254b is corresponding to the locating holes 211b of the jig 201 for being inserted into the locating 211b. Preferably, each set of supporting bars 253 has one set of locating pillars 255 formed thereon. Concretely, each set of locating pillars 255 includes a first locating pillar 255a formed on the first supporting bar 253a and a second locating pillar 255b formed on the second supporting bar 253b, accordingly, positioning holes formed on the HSA includes the first positioning hole formed on the ACA and the second positioning hole formed on the FPCA. Referring to FIG. 3a, when the jig 201 with the HSA 110 is loaded onto the main tray 204, the locating holes 211a and 211b of the jig 201 are mounted on the locating bumps 254a and 254b, respectively. Simultaneously, the ACA 112 of the HSA 110 is supported by the first supporting bar 253a and a first positioning hole formed on the ACA 112 is mounted on the first locating pillar 255a, the FPCA 115 is supported by the first supporting bar 253a and the second supporting bar 253b, a second positioning hole formed on the FPCA 115 is mounted on the second locating pillar 255b, thereby the HSA 110 can be located on the main tray 204 when the jig 201 removing from the HSA 110. Preferably, the first supporting bar 253a further has two first stoppers 256a formed around the first locating pillar 255a and disposed at a side of the ACA 112 for further preventing the ACA 112 from moving. Similarly, the second supporting bar 253b has two second stoppers 256b formed around the second locating pillar 255b and disposed at a side of the FPCA for further preventing the FPCA from moving. As described above, the HSA not only can be located on the main tray by the jig, but also can be located on the HSA without the jig.

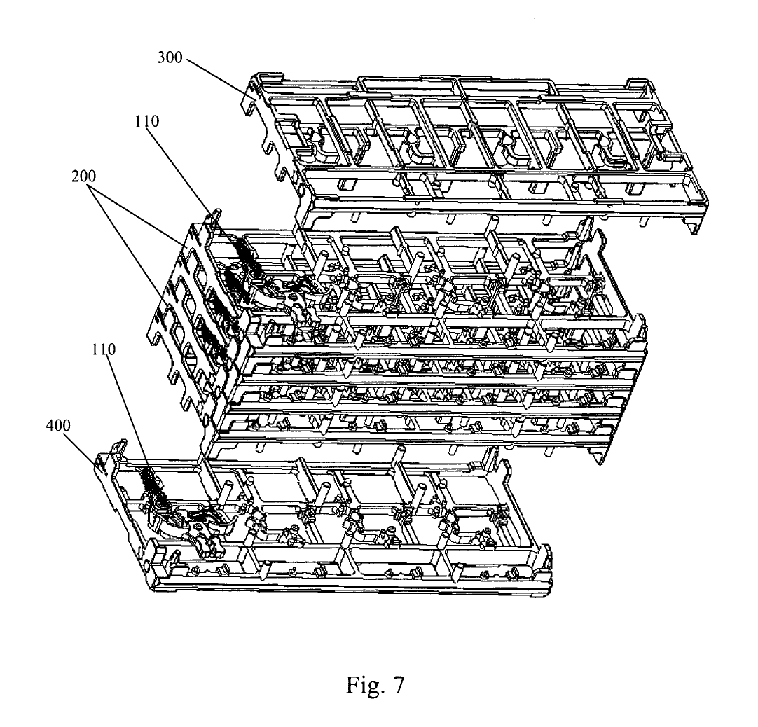

Referring to FIG. 7, the present invention further provides a shipping tool for carrying a plurality of head stack assemblies 110. The shipping tool includes a top process tray 300, a bottom process tray 400 and a plurality of process trays 200. As illustrated in FIG. 6, after the head stack assemblies 110 loaded on the process trays, several process trays 200 are stacked with each other by aligning and engaging the protrusion of one process tray 200 with the cutout of another process tray 200. The top process tray 300 and the bottom process tray 400 are stacked with the process trays 200 at a top and a bottom position, respectively. That is the process trays 200 are sandwiched between the top process tray 300 and the bottom process tray 400. In this embodiment, both of the top process tray 300 and the bottom process tray 400 have a structure similar to that of the process tray 200. Concretely, the top process tray 300 has a downside facing to and stacked with the process tray 200 and the bottom process tray 400 has upside facing to and stacked with the process tray 200. While, for facilitating vacuum packing, the upside of the top process tray 300 opposite to its downside is designed to be flat and without protrusions, similarly, the downside of the bottom process tray 400 opposite to its upside is designed to be flat and without protrusions.

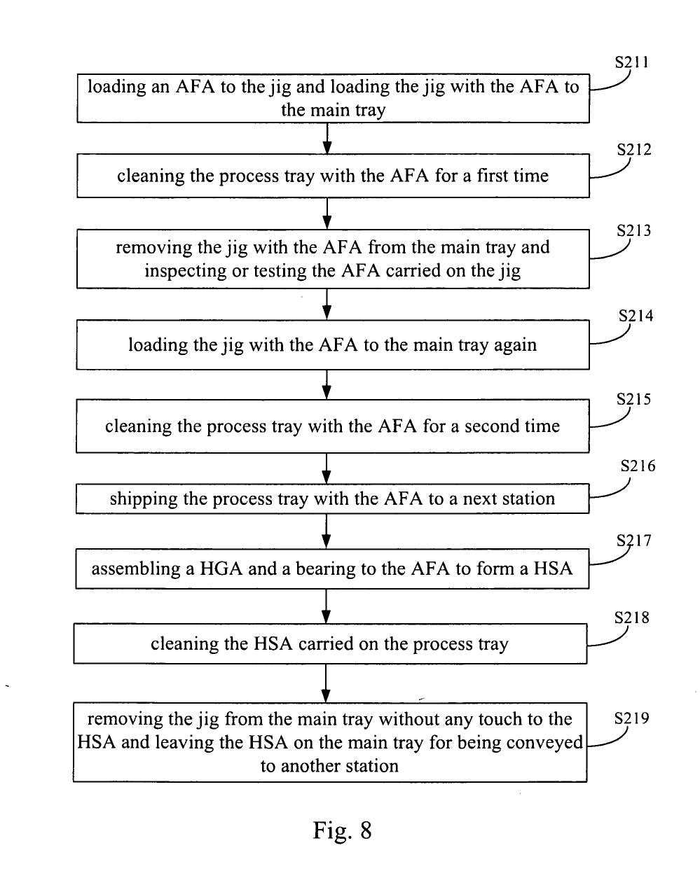

Referring to FIG. 8, the present invention further provides a manufacturing method for a head stack assembly using the process tray 200. This method includes the steps as follows: at first, loading an arm flexible circuit assembly (AFA) to the jig and loading the jig with the AFA to the main tray (step S211 in FIG. 8); next, cleaning the process tray with the AFA for a first time (step S212 in FIG. 8); removing the jig with the AFA from the main tray and inspecting or testing the AFA carried on the jig (step S213 in FIG. 8); and then, loading the jig with the AFA to the main tray again (step S214 in FIG. 8); cleaning the process tray with the AFA for a second time (step S215 in FIG. 8); after that, shipping the process tray with the AFA to a next station (step S216 in FIG. 8); assembling a head gimbal assembly (HGA) and a bearing to the AFA to form a head stack assembly (HSA) (step S217 in FIG. 8); cleaning the HSA carried on the process tray (step S218 in FIG. 8); finally, removing the jig from the main tray without any touch to the HSA and leaving the HSA on the main tray for being conveyed to another station (step S219 in FIG. 8). As indicated above, during the whole process for manufacturing HSA, the AFA/HSA are always carried by the same process tray, thus the load/unload operations of the HSA can be reduced, in turn, no-value stations and operators could be reduced. Thereby the productive efficiency is improved and then the manufacturing cost is reduced. Furthermore, because the process tray of the present invention includes a jig to clamp the AFA/HSA, it is able to avoid contacting the AFA/HSA directly by hand during above-mentioned manufacturing process. Therefore, cross contamination of the AFA/HSA is avoided and visual yield can be improved.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A process tray for carrying head stack assembly, comprising:
at least one jig, each jig having a main body with one set of locating holes formed thereon and two elastic arms respectively extending from two sides of the main body for providing force to hold the head stack assembly;
a main tray having a main frame and a supporting frame disposed within and connected to the main frame for supporting the jig and/or the head stack assembly;
wherein the supporting frame has at least one set of locating bumps formed thereon for locating at least one jig on the main tray by respectively inserting the locating bumps into the locating holes formed on the jig.

2. The process tray as claimed in claim 1, wherein the supporting frame has several sets of locating bumps which are uniformly-spaced for locating several jigs.

3. The process tray as claimed in claim 1, wherein the jig further comprises a handle formed on the top of the main body.

4. The process tray as claimed in claim 3, wherein the handle has a slot formed thereon.

5. The process tray as claimed in claim 1, wherein the elastic arm comprises a protrusion portion and a first clamping portion extending from the bottom end of the protrusion portion, and the jig further comprises a second clamping portion extending from the bottom of the main body and disposed between the first clamping portions.

6. The process tray as claimed in claim 5, wherein both of the first clamping portions have at least one clawlike bump, and the second clamping portion has at least one clawlike bump and a locating pole.

7. The process tray as claimed in claim 1, wherein the supporting frame has at least one set of locating pillars formed thereon for locating at least one head stack assembly on the main tray by respectively inserting the locating pillars into positioning holes formed on the head stack assembly.

8. The process tray as claimed in claim 7, wherein the supporting frame comprises two inner bars connecting to the main frame and several sets of supporting bars which are uniformly-spaced formed thereon for supporting several head stack assemblies.

9. The process tray as claimed in claim 8, each set of supporting bars comprises a first supporting bar and a second supporting bar, and each set of locating pillars comprises a first locating pillar formed on the first supporting bar and a second locating pillar formed on the second supporting bar.

10. The process tray as claimed in claim 9, wherein the first supporting bar has a plurality of first stoppers formed around the first locating pillar and the second supporting bar has a plurality of second stoppers formed around the second locating pillar.

11. The process tray as claimed in claim 1, wherein the main frame comprises a top bar, a bottom bar parallel to the top bar and two opposite side bars connecting to the top bar and bottom bar to form four corners, each corner having an upside with two protrusions and a cutout and a downside with a protrusion.

12. The process tray as claimed in claim 11, wherein the size of protrusions and cutout in one corner is different from that in the other corners.

13. The process tray as claimed in claim 11, wherein the top bar, the bottom bars and the supporting frame all have draft angle.

14. A shipping tool for head stack assemblies comprising a plurality of process trays stacked with each other, each of the process trays comprising:
at least one jig, each jig having a main body with one set of locating holes formed thereon and two elastic arms respectively extending from two sides of the main body for providing force to hold the head stack assembly;
a main tray having a main frame and a supporting frame disposed within and connected to the main frame for supporting the jig and/or the head stack assembly;
wherein the supporting frame has at least one set of locating bumps formed thereon for locating at least one jig on the main tray by respectively inserting into the locating holes formed on the jig.

15. The shipping tool as claimed in claim 14, wherein the shipping tool further comprises a top process tray stacked on the process trays having a downside facing to the process trays and an upside opposite to the downside, the upside of the top process tray being flat.

16. The shipping tool as claimed in claim 14, wherein the shipping tool further comprises a bottom process tray stacked by the process trays having an upside facing to the process trays and a downside opposite to the upside, the downside of the bottom process tray being flat.

17. A manufacturing method for a head stack assembly using the process tray as claimed in any one of claims 1 to 13, the method comprising the steps of:
loading an arm flexible circuit assembly to the jig and loading the jig with the arm flexible circuit assembly to the main tray;
cleaning the process tray with the arm flexible circuit assembly for a first time;
removing the jig with the arm flexible circuit assembly from the main tray and inspecting or testing the arm flexible circuit assembly carried on the jig;
loading the jig with the arm flexible circuit assembly to the main tray again;
cleaning the process tray with the arm flexible circuit assembly for a second time;
shipping the process tray with the arm flexible circuit assembly to a next station;
assembling a head gimbal assembly and a bearing to the arm flexible circuit assembly to form a head stack assembly;
cleaning the head stack assembly carried on the process tray; and
removing the jig from the main tray of the process tray and leaving the head stack assembly on the main tray for being conveyed to another station.
